(19) United States
(12) Patent Application Publication
(10) Pub. No.: US 2021/0396550 A1
(43) Pub. Date: Dec. 23, 2021

(54) POSITION DETECTION DEVICE

(71) Applicant: KABUSHIKI KAISHA TOKAI RIKA DENKI SEISAKUSHO, Aichi (JP)

(72) Inventor: Naoki ISOBE, Aichi (JP)

(21) Appl. No.: 17/345,129

(22) Filed: Jun. 11, 2021

(30) Foreign Application Priority Data
Jun. 18, 2020 (JP) 2020-105608

(51) Int. Cl. G01D 5/14; B60R 25/00; B62D 15/02

(52) U.S. Cl. CPC G01D 5/145; B62D 15/02; B60R 25/007

(57) ABSTRACT

A position detection device includes a magnetic field generating portion to generate a magnetic field and move between a first position and a second position, a first magnetic detection element to detect a first magnetic field, a second magnetic detection element to detect a second magnetic field different from the first magnetic field, and a determination unit to determine that the magnetic field generating portion has reached the first position when the first magnetic detection element and the second magnetic detection element both detect a predetermined threshold value.

### CROSS-REFERENCE TO RELATED APPLICATIONS

The present patent application claims the priority of Japanese patent application No. 2020/105608 filed on Jun. 18, 2020, and the entire contents of Japanese patent application No. 2020/105608 are hereby incorporated by reference.

### TECHNICAL FIELD

The present invention relates to a position detection device.

### BACKGROUND ART

In electric steering lock devices, it must be ensured that a locking member is definitely located in an unlock position while a vehicle is in motion so that rotation of a steering wheel is not locked. One of the measures to achieve it is a method in which a substrate is housed in a substrate housing portion formed on a housing so that an inner surface of the substrate is parallel to an operational direction of a locking member, one Hall element (LOCK_SW) and two (first and second) Hall elements (UNLOCK_SW #1 and #2), which are magnetic detection elements, are provided on the inner surface of the substrate at positions respectively corresponding to a lock position (above) and an unlock position (below), and an operation position detection mechanism is composed of these Hall elements and a magnet provided on the locking member (e.g., Patent Literature 1).

Regarding the two (first and second) Hall elements (UNLOCK_SW #1 and #2), when a locking bolt moves to the unlock position, the first Hall element at a position corresponding to the unlock position becomes distant from a magnet provided on the locking member and is switched from the ON state to the OFF state and the second Hall element becomes close to the magnet provided on the locking member and is switched from the OFF state to the ON state, and this causes a microcomputer to determine that the locking bolt has moved to the unlock position.

According to this method, whether or not one of the two Hall elements is failing can be checked based on an output of the other. In addition, even if a strong electromagnetic field is generated during when the locking bolt is moving, not both of the first and second Hall elements suddenly change to the opposite state. Therefore, the device does not erroneously determine that the locking bolt has moved to the unlock position even though the locking bolt is not in the unlock position, and it is thus possible to avoid the risk that the engine is started in the state in which the locking bolt stops halfway through and rotation of the steering wheel is locked.

### CITATION LIST

### Patent Literature

Patent Literature 1: JP 2012/25269 A

### SUMMARY OF INVENTION

In the position detection device disclosed in Patent Literature 1, however, the two Hall elements corresponding to the unlock position need to be arranged at different positions in the movement direction of the magnet.

In addition, it is not possible to arrange the two Hall elements in the required positions in some cases such as, e.g., a case of detecting the rotational position of the magnet provided on a gear and when movement of the magnet is not parallel to the substrate on which the Hall elements are mounted. Thus, a problem may arise that it is not possible to suppress improper operation due to an external magnetic field.

It is an object of the invention to provide a position detection device that is capable of suppressing improper operation due to an external magnetic field without arranging two magnetic detection elements, which correspond to a predetermined position, at different positions in a movement direction of a magnetic field generating body.

According to an embodiment of the invention, a position detection device comprises:
a magnetic field generating portion to generate a magnetic field and move between a first position and a second position;
a first magnetic detection element to detect a first magnetic field;
a second magnetic detection element to detect a second magnetic field different from the first magnetic field; and
a determination unit to determine that the magnetic field generating portion has reached the first position when the first magnetic detection element and the second magnetic detection element both detect a predetermined threshold value.

### ADVANTAGEOUS EFFECTS OF INVENTION

According to an embodiment of the invention, a position detection device can be provided that is capable of suppressing improper operation due to an external magnetic field without arranging two magnetic detection elements, which correspond to a predetermined position, at different positions in a movement direction of a magnetic field generating body.

### BRIEF DESCRIPTION OF DRAWINGS

FIGS. 1A and 1B are explanatory diagrams of a position detection device in the first embodiment of the present invention, wherein FIG. 1A is a schematic structural diagram when viewed from above, and FIG. 1B is an explanatory configuration diagram that is a transparent view when viewed from a lateral surface in combination with a block diagram.

FIG. 2 is a perspective view showing a magnet used in the position detection device in the first embodiment of the invention.

FIGS. 3A and 3B are characteristic diagrams of magnetic detection elements used in the position detection device in the first embodiment of the invention, wherein FIG. 3A is a characteristic diagram of a first magnetic detection element and FIG. 3B is a characteristic diagram of a second magnetic detection element.

FIGS. 4A to 4C are explanatory diagrams of the position detection device in the first embodiment of the invention, wherein FIG. 4A is a schematic structural diagram when viewed from above, FIG. 4B is a cross sectional view taken along a line A-A in FIG. 4A, and FIG. 4C is a cross sectional view taken along a line B-B in FIG. 4A.

FIG. 5 is a flowchart of a determination program for a determination unit of the position detection device in the first embodiment of the invention.

FIGS. 6A to 6D are characteristic diagrams of the position detection device in the first embodiment of the invention associated with the position of a magnet when a rotating support rod is rotated, wherein FIG. 6A is a diagram illustrating a distance relation between the magnet and the magnetic detection elements, FIG. 6B is a characteristic diagram illustrating a magnetic flux density in the magnetic detection elements, FIG. 6C is a characteristic diagram illustrating output signals of the first and second magnetic detection elements, and FIG. 6D is a characteristic diagram illustrating an output signal of a third magnetic detection element.

FIG. 7 is a partial schematic structural diagram illustrating the position detection device in the second embodiment.

FIG. 8 is a characteristic diagram of the magnetic detection element used in the position detection device in the second embodiment of the invention.

FIG. 9 is a partial schematic structural diagram illustrating the position detection device in a modification of the second embodiment.

FIG. 10 is a partial schematic structural diagram illustrating the position detection device in the third embodiment.

FIGS. 11A and 11B show partial schematic structural diagrams illustrating the position detection device in the fourth embodiment.

FIG. 12 is a circuit configuration diagram illustrating the magnetic detection element of the position detection device in the fourth embodiment.

### DESCRIPTION OF EMBODIMENTS

### First Embodiment

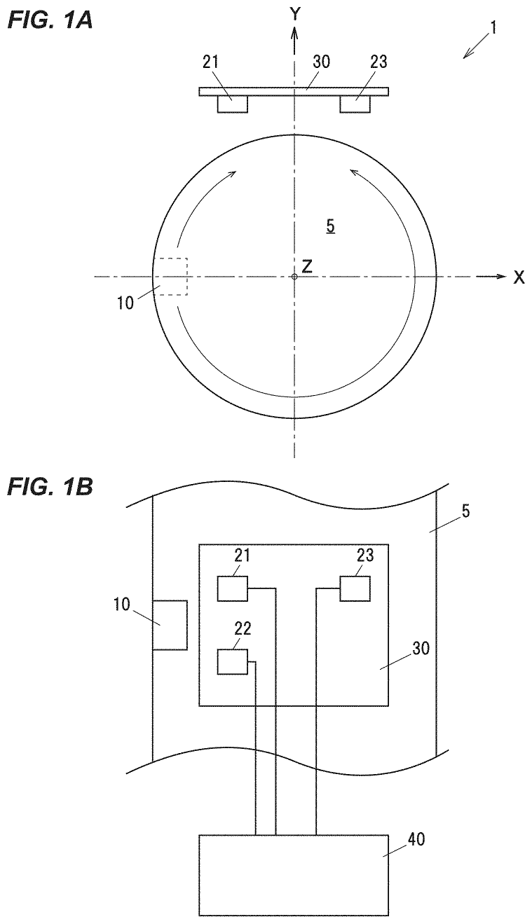

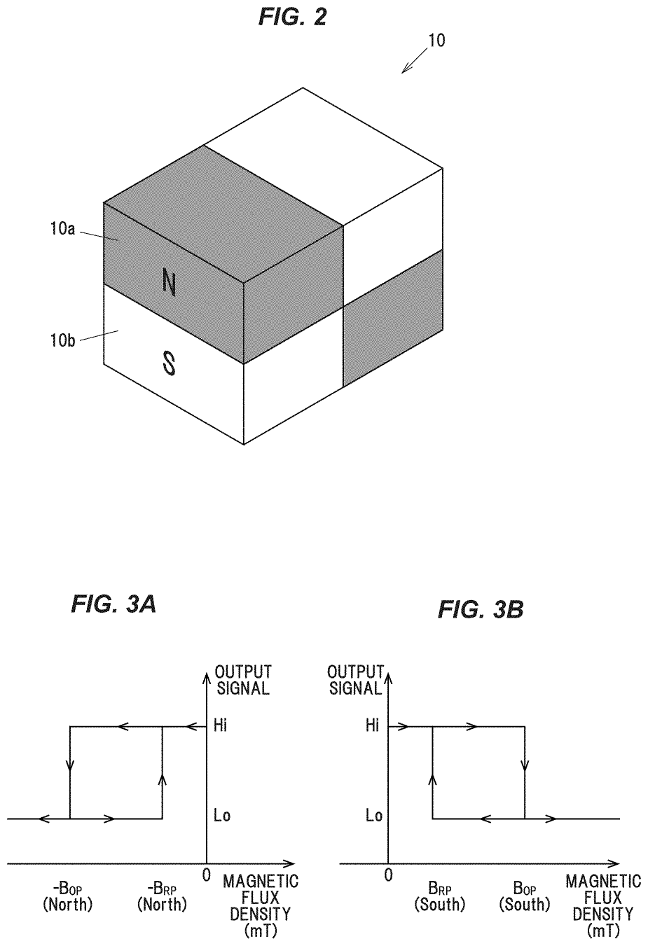

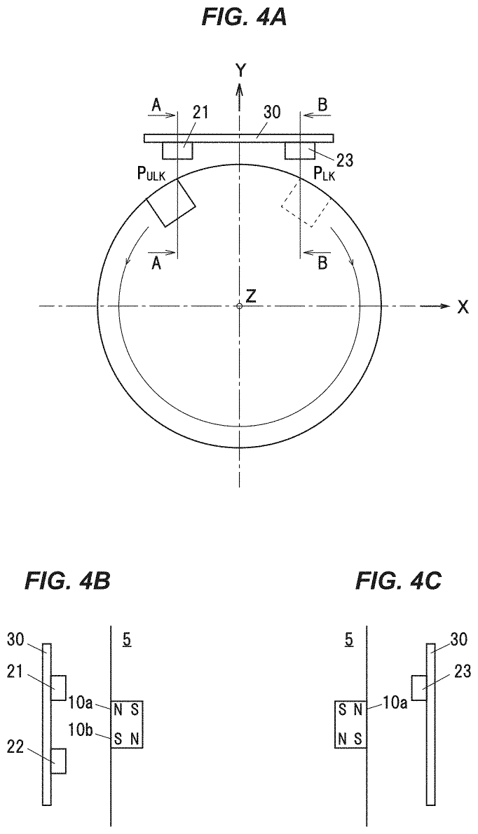

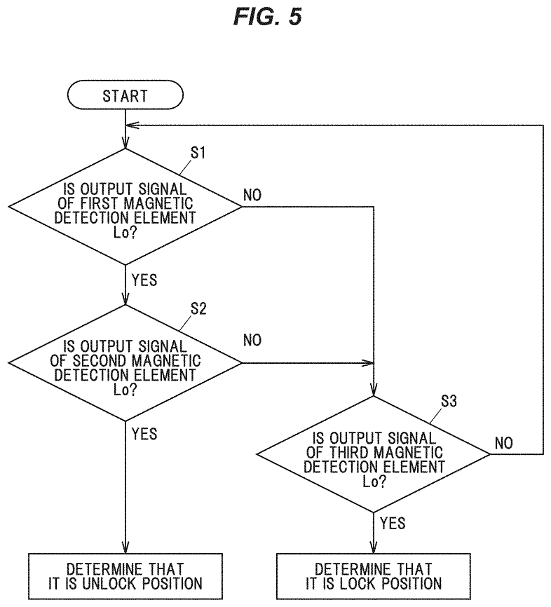

FIGS. 1A and 1B are explanatory diagrams of a position detection device in the first embodiment of the invention. FIG. 1A is a schematic structural diagram when viewed from above, and FIG. 1B is an explanatory configuration diagram that is a transparent view when viewed from a lateral surface in combination with a block diagram. FIG. 2 is a perspective view showing a magnet used in the position detection device in the first embodiment of the invention. FIGS. 3A and 3B are characteristic diagrams of magnetic detection elements used in the position detection device in the first embodiment of the invention. FIG. 3A is a characteristic diagram of a first magnetic detection element and FIG. 3B is a characteristic diagram of a second magnetic detection element. FIGS. 4A to 4C are explanatory diagrams of the position detection device in the first embodiment of the invention. FIG. 4A is a schematic structural diagram when viewed from above, FIG. 4B is a cross sectional view taken along the line A-A in FIG. 4A, and FIG. 4C is a cross sectional view taken along the line B-B in FIG. 4A. FIG. 5 is a flowchart of a determination program for a determination unit of the position detection device in the first embodiment of the invention.

As shown in FIG. 1A, a position detection device 1 in the embodiment of the invention includes a magnet 10 attached to a rotating support rod 5, a first magnetic detection element 21, a second magnetic detection element 22 and a third magnetic detection element 23 that are mounted on a substrate 30, and a determination unit 40 that determines a rotational position of the rotating support rod 5 based on signals from the first magnetic detection element 21, the second magnetic detection element 22 and the third magnetic detection element 23.

The rotating support rod 5 is attached so as to be rotatable about a rotational axis (a Z-axis). The rotating support rod 5 is linked to and moves with a locking member (not shown) that locks rotation of a steering wheel (not shown). The rotating support rod 5 rotates between a locked state position and an unlocked state position within an angular range close to 360°. The locked state position is a rotated position of the rotating support rod 5 when the locking member is locking the rotation of the steering wheel. The unlocked state position is a rotated position of the rotating support rod 5 when the locking member is not locking the rotation of the steering wheel.

The magnet 10 is a rectangular parallelepiped-shaped single-sided bipolar permanent magnet, as shown in FIG. 2. The magnet 10 is magnetized such that two pairs of N-pole and S-pole are combined in opposite directions, and it is a magnet that has two N-poles and two S-poles. As shown in FIG. 4B, the magnet 10 is attached so that a side having an N-pole 10a and an S-pole 10b on one face is located on a lateral surface side of the rotating support rod 5. The polarity on the lateral surface side is such that the N-pole 10a and the S-pole 10b are aligned in a rotational axis direction of the rotating support rod 5 (in a Z-axis direction), with the N-pole 10a on the upper side of FIG. 1B and the S-pole 10b on the lower side.

The first magnetic detection element 21 is a unipolar switch-type Hall element (an IC having a signal processing circuit) for N-pole detection. The output signal of the first magnetic detection element 21 becomes Lo when the N-pole approaches and the output signal becomes Hi when the N-pole moves away.

That is, as shown in FIG. 3A, the unipolar switch-type Hall element for N-pole detection has characteristics that the output signal is Hi in the absence of a magnetic field from the N-pole. The output signal becomes Lo when the N-pole approaches and the magnitude of a magnetic flux density increases and reaches an operating magnetic flux density: Bop as a threshold. The output signal stays LO even if the magnitude of the magnetic flux density further increases. On the other hand, when, from the Lo state of the output signal, the N-pole moves away and the magnitude of the magnetic flux density decreases and reaches a release magnetic flux density: Brp, the output signal becomes Hi. The output signal stays Hi even if the magnitude of the magnetic flux density further decreases.

The second magnetic detection element 22 is a unipolar switch-type Hall element (an IC having a signal processing circuit) for S-pole detection. The output signal of the second magnetic detection element 22 becomes Lo when the S-pole approaches and the output signal becomes Hi when the S-pole moves away.

That is, as shown in FIG. 3B, the unipolar switch-type Hall element for S-pole detection has characteristics that the output signal is Hi in the absence of a magnetic field to the S-pole. The output signal becomes Lo when the S-pole approaches and the magnetic flux density increases and reaches the operating magnetic flux density: Bop as the threshold. The output signal stays LO even if the magnetic flux density further increases. On the other hand, when, from the Lo state of the output signal, the S-pole moves away and the magnetic flux density decreases and reaches the release magnetic flux density: Brp, the output signal becomes Hi. The output signal stays Hi even if the magnetic flux density further decreases.

The first magnetic detection element 21, which is the unipolar switch-type Hall element for N-pole detection, detects a magnetic flux density of a directional component from the N-pole. On the other hand, the second magnetic detection element 22, which is the unipolar switch-type Hall element for S-pole detection, detects a magnetic flux density of a directional component to the S-pole. The values of the operating magnetic flux density and the release magnetic flux density of the first magnetic detection element 21 and those of the second magnetic detection element 22 are respectively of the same magnitudes but are opposite directions.

The third magnetic detection element 23 is a unipolar switch-type Hall element (an IC having a signal processing circuit) for N-pole detection in the same manner as the first magnetic detection element 21.

The first magnetic detection element 21, the second magnetic detection element 22 and the third magnetic detection element 23 have magnetic sensing surfaces parallel to the magnetic detection element-mounting surface and sense a magnetic field in a direction perpendicular to the magnetic sensing surfaces. The magnetic flux density on the horizontal axes in FIGS. 3A and 3B is positive in a direction from a back surface of the Hall element on the substrate 30 side toward an upper surface of the Hall element to which the magnet 10 approaches.

The substrate 30 is a circuit board formed of an insulating material and has a metal circuit pattern (not shown) on a surface. As shown in FIG. 1A, the substrate 30 is arranged near a cylindrical surface of the rotating support rod 5 along the rotational axis of the rotating support rod 5 so that a normal direction to a surface of the substrate 30 is parallel to the X-axis, and the substrate 30 is attached and fixed to a fixed portion (not shown).

The first magnetic detection element 21, the second magnetic detection element 22 and the third magnetic detection element 23 are mounted on the substrate 30 and are electrically connected to the circuit pattern on the substrate 30. The first magnetic detection element 21, the second magnetic detection element 22 and the third magnetic detection element 23 are then electrically connected to the determination unit 40, as shown in FIG. 1B.

The magnetic sensing surfaces of the first magnetic detection element 21, the second magnetic detection element 22 and the third magnetic detection element 23 are positioned parallel to the substrate 30. In addition, these magnetic sensing surfaces are positioned so that normal lines thereof are orthogonal to a direction of the rotational axis of the rotating support rod 5.

Positions of the magnet 10 on a circumference of the rotating support rod 5 corresponding to rotation angles of the rotating support rod 5 rotating between the locked state position and the unlocked state position are the unlock position: PULK indicated by the solid line in FIG. 4A and the lock position: PLK indicated by the dashed line. The first magnetic detection element 21, the second magnetic detection element 22 and the third magnetic detection element 23 mounted on the substrate 30 are arranged at positions corresponding to the positions of the magnet 10 when in the unlock position and the lock position.

That is, when the magnet 10 is in the unlock position as shown in FIG. 4B, the first magnetic detection element 21 as the unipolar switch-type Hall element for N-pole detection is close to the N-pole 10a of the single-sided bipolar magnet 10. The second magnetic detection element 22 as the unipolar switch-type Hall element for S-pole detection is close to the S-pole 10b of the magnet 10. In addition, the first magnetic detection element 21 and the second magnetic detection element 22 are arranged symmetrically in the rotational axis direction of the rotating support rod 5, so are the N-pole 10a and the S-pole 10b of the magnet 10. The positions of the first magnetic detection element 21 and the second magnetic detection element 22 are the same in the X-axis and Y-axis directions and different in the Z-axis direction.

Meanwhile, when the magnet 10 is in the lock position as shown in FIG. 4C, the third magnetic detection element 23 as the unipolar switch-type Hall element for N-pole detection is close to the N-pole 10a of the magnet 10. The first magnetic detection element 21 and the third magnetic detection element 23 are arranged symmetrically with respect to the Y-axis.

The determination unit 40 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the control unit. The RAM is used as, e.g., a storage area for temporarily storing calculated detection information, etc.

The determination unit 40 stores a program for determining that the magnet 10 has reached the unlock position or the lock position based on signals output from the first magnetic detection element 21, the second magnetic detection element 22 and the third magnetic detection element 23.

This program determines that the magnet 10 has reached the unlock position when the output signals from the first magnetic detection element 21 and the second magnetic detection element 22 are both Lo. This program also determines that the magnet 10 has reached the lock position when the output signal from the third magnetic detection element 23 is Lo.

That is, in S1, the determination unit 40 checks whether the output signal from the first magnetic detection element 21 is Lo, as shown in the flowchart of FIG. 5. When it is Lo, the determination unit 40 further checks whether the output signal from the second magnetic detection element 22 is Lo in S2. When it is Lo, the determination unit 40 determines that the magnet 10 has reached the unlock position.

Meanwhile, when the output signal from the first magnetic detection element 21 is not Lo in Si and when the output signal from the second magnetic detection element 22 is not Lo in S2, the determination unit 40 checks whether the output signal from the third magnetic detection element 23 is Lo in S3. When it is Lo, the determination unit 40 determines that the magnet 10 has reached the lock position.

### Operation of the Position Detection Device

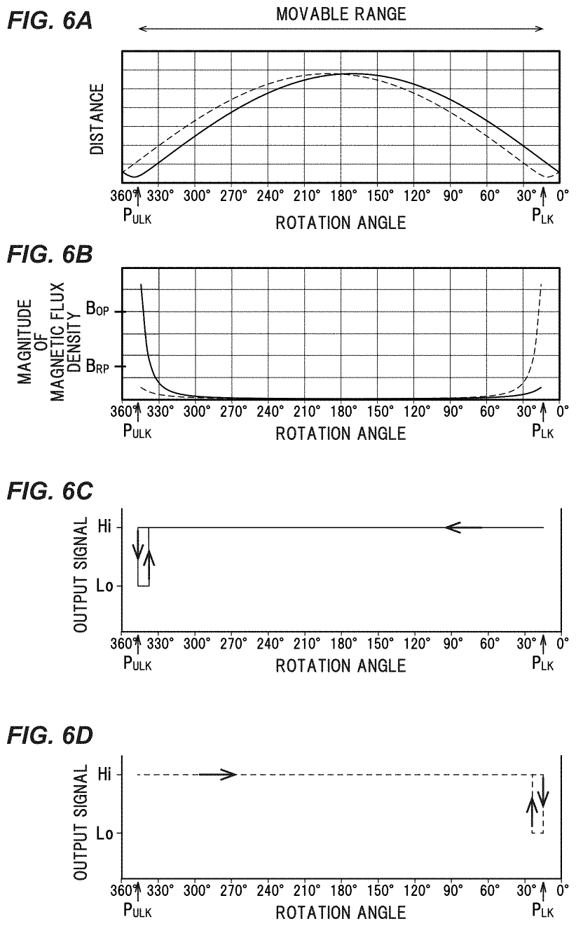

FIGS. 6A to 6D are characteristic diagrams of the position detection device in the first embodiment of the invention associated with the position of the magnet when the rotating support rod is rotated. FIG. 6A is a diagram illustrating a distance relation between the magnet and the magnetic detection elements, FIG. 6B is a characteristic diagram illustrating a magnetic flux density in the magnetic detection elements, FIG. 6C is a characteristic diagram illustrating the output signals of the first and second magnetic detection elements, and FIG. 6D is a characteristic diagram illustrating the output signal of the third magnetic detection element.

The rotation angle of the rotating support rod 5 on the horizontal axes in FIGS. 6A to 6D is defined based on a reference position where the magnet 10 is on the Y-axis in FIG. 4A and is closest to the substrate 30. In addition, the positive direction is a direction in which the rotating support rod 5 rotates from this rotation angle toward the lock position: PLK (clockwise rotation in FIG. 4A). However, the magnet 10 will not be located at the reference position. By the rotation of the rotating support rod 5, the magnet 10 moves between the lock position: PLK and the unlock position: PULK, which is not on the reference position side.

Distances between the first magnetic detection element 21/the second magnetic detection element 22 and the magnet 10 and a distance between the third magnetic detection element 23 and the magnet 10 change as shown in FIG. 6A due to movement of the magnet 10 caused by the rotation of the rotating support rod 5.

That is, the distances between the first magnetic detection element 21/the second magnetic detection element 22 and the magnet 10 indicated by the solid line increase and reaches the maximum around 170° as the magnet 10 moves from the lock position: PLK in the positive direction within a movable range, and then, the distances decrease as approaching the unlock position: PULK. Meanwhile, the distance between the third magnetic detection element 23 and the magnet 10 indicated by the dashed line increases and reaches the maximum around 190° as the magnet 10 moves from the unlock position: PULK in the negative direction within the movable range, and then, the distance decreases as approaching the lock position: PLK.

As shown in FIG. 6B, the magnetic flux density from the magnet 10 at the positions of the first magnetic detection element 21 and the second magnetic detection element 22 indicated by the solid line and the magnetic flux density from the magnet 10 at the position of the third magnetic detection element 23 indicated by the dashed line are approximately inversely proportional to the square of the distance from the magnet 10.

When the magnet 10 moves from the lock position: PLK to the unlock position: PULK as indicated by the solid line, the value of the magnetic flux density from the magnet 10 at the positions of the first magnetic detection element 21 and the second magnetic detection element 22 indicated by the solid line is less than ⅕ of the operating magnetic flux density: Bop between the lock position: PLK and 330° which is close to the unlock position: PULK. Then, the magnetic flux density from the magnet 10 sharply increases from around 340° and exceeds the operating magnetic flux density: Bop at the unlock position: PULK.

On the other hand, when the magnet 10 moves from the unlock position: PULK to the lock position: PLK, the value of magnetic flux density from the magnet 10 at the position of the third magnetic detection element 23 indicated by the dashed line is less than ⅕ of the operating magnetic flux density: Bop between the unlock position: PULK to 30° which is close to the lock position: PLK. Then, the magnetic flux density from the magnet 10 sharply increases from around 20° and exceeds the operating magnetic flux density: Bop at the lock position: PLK.

The direction of the magnetic field in the first magnetic detection element 21 at the unlock position and in the third magnetic detection element 23 at the lock position is from the N-pole of the magnet 10 toward the substrate 30. The direction of the magnetic field in the second magnetic detection element 22 at the unlock position is from the S-pole of the magnet 10 toward the substrate 30. Meanwhile, the magnetic detection element composed of the Hall element detects the magnetic flux density of a directional component perpendicular to the magnetic sensing surface. The magnitude of the magnetic flux density of a perpendicular component to the magnetic sensing surfaces of the first magnetic detection element 21 and the second magnetic detection element 22 reaches the operating magnetic flux density: Bop as the threshold at the unlock position. The magnitude of the magnetic flux density of the perpendicular component to the magnetic sensing surface of the third magnetic detection element 23 reaches the operating magnetic flux density: Bop as the threshold at the lock position.

The change in the perpendicular component of the magnetic flux density at the magnetic sensing surface of the magnetic detection element near the unlock position: PULK and the lock position: PLK caused by the rotation of the rotating support rod 5 is a sharper change than the change in the magnitude of the magnetic flux density. Thus, detection position accuracy increases. In addition, at around 90 degrees or 270 degrees, the direction of the magnetic flux is parallel to the magnetic sensing surface and the perpendicular component of the magnetic flux density thus becomes zero.

As shown in FIG. 6C, when the magnet 10 moves from the lock position: PLK to the unlock position: PULK, the output signals of the first magnetic detection element 21 and the second magnetic detection element 22 indicated by the solid line is Hi until just before the magnet 10 reaches the unlock position: PULK. When the magnet 10 reaches the unlock position: PULK, the output signals of the first magnetic detection element 21 and the second magnetic detection element 22 become Lo.

Then, according to the determination program, the determination unit 40 determines that the magnet 10 has reached the unlock position.

In case that the magnet 10 moves from the unlock position: PULK to the lock position: PLK, the output signals of the first magnetic detection element 21 and the second magnetic detection element 22 change from Lo to Hi when the magnet 10 moves away from the unlock position: PULK by several degrees, as shown in FIG. 6C. After that, the output signals stay Hi until reaching the lock position: PLK.

As shown in FIG. 6D, when the magnet 10 moves from the unlock position: PULK to the lock position: PLK, the output signal of the third magnetic detection element 23 indicated by the dashed line is Hi until just before the magnet 10 reaches the lock position: PLK. When the magnet 10 reaches the lock position: PLK, the output signal of the third magnetic detection element 23 becomes Lo.

Then, according to the determination program, the determination unit 40 determines that the magnet 10 has reached the lock position, based on the fact that the output signal of the third magnetic detection element 23 has become Lo.

In case that the magnet 10 moves from the lock position: PLK to the unlock position: PULK, the output signal of the third magnetic detection element 23 changes from Lo to Hi when the magnet 10 moves away from the lock position: PLK by several degrees, as shown in FIG. 6D. After that, the output signal stays Hi until reaching the unlock position: PULK.

When a disturbance magnetic field is generated in a state that the magnet 10 has not reached the unlock position, one of the output signals of the first magnetic detection element 21 and the second magnetic detection element 22 arranged in the same direction may become Lo, but not both of the output signals become Lo. That is, as shown in the characteristic diagrams of the magnetic detection elements in FIGS. 3A and 3B, the first magnetic detection element 21 and the second magnetic detection element 22 are sensitive only to magnetic fields in one direction that differ by 180 degrees. Therefore, not both of the output signals become Lo even if a strong disturbance magnetic field is generated.

In addition, the first magnetic detection element 21 and the second magnetic detection element 22 are arranged so as to be along the same rotational direction of the rotating support rod 5 (wherein they have positions in the X-axis and Y-axis directions are the same), so that the first magnetic detection element 21 and the second magnetic detection element 22 do not suddenly simultaneously change to the opposite state even if a strong electromagnetic field is generated during when the rotating support rod 5 is moving. Thus, the determination unit 40 does not erroneously determine that the lock position has been reached.

### Effects of the First Embodiment Of The Invention

In the embodiment of the invention described above, it is configured that the first magnetic detection element detecting the magnetic field from the N-pole and the second magnetic detection element detecting the magnetic field from the S-pole are used to detect and determine that the unlock position has been reached. As a result, an effect of suppressing improper operation due to an external magnetic field is obtained without arranging two magnetic detection elements at different positions.

### The Second Embodiment

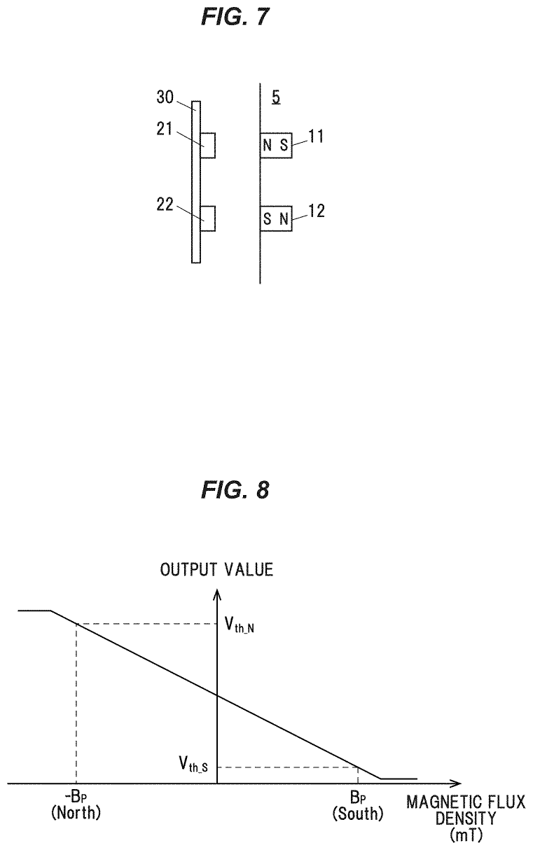

FIG. 7 is a partial schematic structural diagram illustrating the position detection device in the second embodiment. FIG. 8 is a characteristic diagram of the magnetic detection element used in the position detection device in the second embodiment of the invention. In the following description, portions having the same configurations and functions as those of the first embodiment are denoted by the same reference numerals.

In the first embodiment, the magnet is composed of one single-sided bipolar magnet, and the first and second magnetic detection elements are the unipolar switch-type Hall element for N-pole detection and the unipolar switch-type Hall element for S-pole detection. The second embodiment is different in that the magnet is composed of two magnets each having a pair of N-pole and S-pole and the first and second magnetic detection elements are linear-type Hall elements with the same specifications. It is also different that the determination unit determines whether the output signal is Hi or Lo.

A position detection device 2 in the second embodiment includes a first magnet 11 and a second magnet 12 each having a pair of N-pole and S-pole, as shown in FIG. 7. The first magnet 11 is attached so that the N-pole is located on the lateral surface side of the rotating support rod 5, and the second magnet 12 is attached so that the S-pole is located on the lateral surface side of the rotating support rod 5. When the first magnet 11 and the second magnet 12 are in the unlock position, the first magnetic detection element 21 is close to the N-pole of the first magnet 11 and the second magnetic detection element 22 is close to the S-pole of the second magnet 12. As such, separate magnets are provided for the first magnetic detection element 21 and the second magnetic detection element 22.

The first magnetic detection element 21 and the second magnetic detection element 22 are linear-type Hall elements. Characteristics of the linear-type Hall element are such that an output value, which is output as a voltage value, is proportional to the magnetic flux density of the magnetic field within a predetermined range, as shown in FIG. 8. That is, the output voltage is large when the magnetic flux density from the N-pole is large, and the output voltage is small when the magnetic flux density to the S-pole is large. The value is an intermediate value when there is no magnetic field.

Then, the magnitude of the magnetic flux density from the magnet 10 at the positions of the first magnetic detection element 21 and the second magnetic detection element 22 is set to exceed a magnetic flux density: Bp at the unlock position: PULK. The first magnetic detection element 21, when detected a magnetic flux density: −Bp, outputs Vth_N. The second magnetic detection element 22, when detected the magnetic flux density: Bp, outputs Vth_S.

When the output of the first magnetic detection element 21 is not less than the threshold: Vth_N, the determination unit 40 determines that the output signal of the first magnetic detection element 21 is Lo. Meanwhile, when the output of the second magnetic detection element 22 is not more than the threshold: Vth_S, the determination unit 40 determines that the output signal of the second magnetic detection element 22 is Lo. That is, the determination unit 40 makes a determination based on detection of the N-pole magnetic field from the N-pole and detection of the S-pole magnetic field from the S-pole. Then, the unlock position or the lock position is determined in accordance with the flow shown in FIG. 5 in the same manner as the first embodiment.

When a disturbance magnetic field is generated, the first magnetic detection element 21 does not become not less than Vth_N at the same time that the second magnetic detection element 22 becomes not more than Vth_S, as shown in the characteristic diagram of the magnetic detection elements in FIG. 8. Therefore, not both of the output signals become Lo even if a strong disturbance magnetic field is generated.

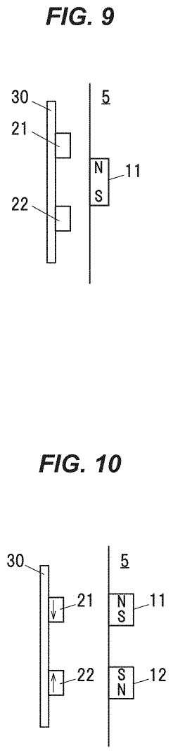

FIG. 9 is a partial schematic structural diagram illustrating the position detection device in a modification of the second embodiment.

In a modification of the second embodiment, the first magnet 11 having a pair of N-pole and S-pole in the second embodiment is attached so that both poles are located on the lateral surface side of the rotating support rod 5, as shown in FIG. 9. When the first magnet 11 is in the unlock position, the first magnetic detection element 21 and the second magnetic detection element 22 are respectively close to the N-pole and the S-pole of one magnet. To strengthen the magnetic force of the magnet, distances between the first magnet 11 and the first magnetic detection element 21/the second magnetic detection element 22 are set to short. Alternatively, e.g., a magnetic material such as a yoke material may be used to strengthen the magnetic force.

Also, in the second embodiment in which the first magnetic detection element 21 and the second magnetic detection element 22 are the linear-type Hall elements with the same specifications and the determination unit 40 determines that the output signals thereof reach the magnitudes of the magnetic fields in the opposite directions as described above, it is possible to obtain the functions and effects described for the first embodiment.

### Third Embodiment

FIG. 10 is a partial schematic structural diagram illustrating the position detection device in the third embodiment.

In the first and second embodiments, the magnetic detection elements are Hall elements and detect magnetic fields in a direction orthogonal to the central axis of the rotating support rod 5. The third embodiment is different from the first and second embodiments in that the magnetic detection elements are magnetoresistive elements and detect magnetic fields in a direction along the central axis of rotating support rod 5.

A position detection device 3 in the third embodiment includes the first magnet 11 and the second magnet 12 each having a pair of N-pole and S-pole, as shown in FIG. 10. Each of the first magnet 11 and the second magnet 12 is attached so that both poles are located on the lateral surface side of the rotating support rod 5. The two poles of the first magnet 11 and the two poles of the second magnet 12 are aligned in the rotational axis direction of the rotating support rod 5 (in the Z-axis direction) in the order of the N-pole of the first magnet 11, the S-pole of the first magnet 11, the S-pole of the second magnet 12 and the N-pole of the second magnet 12.

The first magnetic detection element 21 and the second magnetic detection element 22 of the position detection device 3 in the third embodiment are GMR (Giant Magnetoresistance Effect) elements that are magnetoresistive elements. The magnetic sensing surface of the GMR element is a surface parallel to the substrate 30. The GMR element is an element of which resistance value changes in a direction of the magnetic field along the magnetic sensing surface. That is, there is a characteristic change corresponding to a cosine value of an angle of the magnetic field direction with respect to a predetermined direction (a direction of arrow in the first magnetic detection element 21 or the second magnetic detection element 22 in FIG. 10). The resistance value takes the minimum value when the magnetic field direction is the same as the predetermined direction, and the resistance value takes the maximum value when the magnetic field direction is an opposite direction.

The first magnetic detection element 21 and the second magnetic detection element 22 are mounted on the substrate 30 so that their predetermined directions described above are opposite to each other. When the first magnet 11 and the second magnet 12 are in the unlock position, the first magnetic detection element 21 is located close to the first magnet 11 and the magnetic field passing from the N-pole to the S-pole of the first magnet 11 passes in the direction of arrow. Meanwhile, the second magnetic detection element 22 is located close to the second magnet 12 and the magnetic field passing from the N-pole to the S-pole of the second magnet 12 passes in the direction of arrow.

The determination unit 40 has threshold values for the outputs of the first magnetic detection element 21 and the second magnetic detection element 22 that are outputted when the first magnet 11 and the second magnet 12 are in the unlock position, and makes a determination of Lo or Hi and a determination of the unlock position, in the same manner as the second embodiment.

The first magnetic detection element 21 and the second magnetic detection element 22 are mounted on the substrate 30 so that the predetermined directions described above are opposite to each other. Therefore, even when a disturbance magnetic field is generated, not both of resistance values become low. Thus, not both of the output signals become Lo even if a strong disturbance magnetic field is generated.

Also, in the third embodiment in which the magnetic detection elements are magnetoresistive elements and detect the magnetic fields that are in 180 degrees different directions along the central axis of the rotating support rod 5, it is possible to obtain the functions and effects described for the first embodiment.

The same can be achieved by using TMR (Tunnel Magnetoresistance Effect) elements instead of using the GMR elements.

### Fourth Embodiment

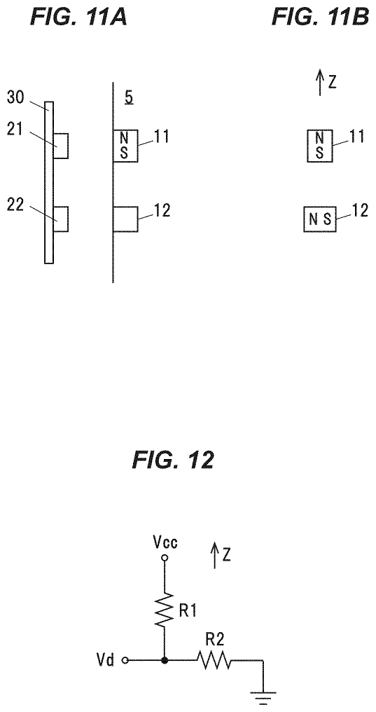

FIGS. 11A and 11B show partial schematic structural diagrams illustrating the position detection device in the fourth embodiment. FIG. 12 is a circuit configuration diagram illustrating the magnetic detection element of the position detection device in the fourth embodiment.

The fourth embodiment is the same as the third embodiment in that the magnetic detection elements are magnetoresistive elements, but is different in the type of the magnetic resistance elements and the direction of the magnetic field detection.

A position detection device 4 in the fourth embodiment includes the first magnet 11 and the second magnet 12 each having a pair of N-pole and S-pole, as shown in FIG. 11A. Each of the first magnet 11 and the second magnet 12 is attached so that both poles are located on the lateral surface side of the rotating support rod 5. The two poles of the first magnet 11 are aligned in the rotational axis direction of the rotating support rod 5 (in the Z-axis direction), with the N-pole on the upper side and the S-pole on the lower side, as shown in FIG. 11B. The two poles of the second magnet 12 are aligned in a direction orthogonal to the rotational axis direction of the rotating support rod 5 (orthogonal to the Z-axis direction), with the N-pole on the left side and the S-pole on the right side.

The first magnetic detection element 21 and the second magnetic detection element 22 are AMR (Anisotropic Magnetoresistance Effect) elements that are magnetoresistive elements. The AMR element is an element of which resistance value increases due to a magnetic field having a directional component perpendicular to a current flowing direction.

The magnetic sensing surfaces of the first magnetic detection element 21 and the second magnetic detection element 22 are formed of an AMR element: R1 arranged in the Z-axis direction and an AMR element: R2 arranged in a direction orthogonal to the Z-axis direction, as shown in FIG. 12. Thus, an intermediate voltage: Vd at an intermediate position between the AMR element: R1 and the AMR element: R2 is Vcc/2 in the absence of the magnetic field. In the presence of the magnetic field in the Z direction, the resistance value of R2 becomes large and the intermediate voltage: Vd becomes a value smaller than Vcc/2. In the presence of the magnetic field in a direction orthogonal to the Z direction, the resistance value of R1 becomes large and the intermediate voltage: Vd becomes a value larger than Vcc/2.

The first magnetic detection element 21 and the second magnetic detection element 22 are mounted on the substrate 30 so as to be in the same direction. The magnetic sensing surfaces of the first magnetic detection element 21 and the second magnetic detection element 22 are surfaces parallel to the substrate 30.

When the first magnet 11 and the second magnet 12 are in the unlock position, the first magnetic detection element 21 is located close to the first magnet 11 and the magnetic field passing from the N-pole to the S-pole of the first magnet 11 passes in the Z axis direction. Meanwhile, the second magnetic detection element 22 is located close to the second magnet 12 and the magnetic field passing from the N-pole to the S-pole of the second magnet 12 passes in the direction orthogonal to the Z-axis. Thus, the intermediate voltage: Vd of the first magnetic detection element 21 takes the minimum value. On the other hand, the intermediate voltage: Vd of the second magnetic detection element 22 takes the maximum value.

The determination unit 40 has the threshold values for the outputs of the first magnetic detection element 21 and the second magnetic detection element 22 that are outputted when the first magnet 11 and the second magnet 12 are in the unlock position, in the same manner as the second embodiment. In the fourth embodiment, the minimum value of the first magnetic detection element 21 and the maximum value of the second magnetic detection element 22 described above are the threshold values. Based on this, a determination of Lo or Hi and a determination of the unlock position are made.

Since the direction of the magnetic field that reaches the threshold is 90 degrees different between the first magnetic detection element 21 and the second magnetic detection element 22, not both have the intermediate voltage: Vd reaching the threshold when a disturbance magnetic field is generated. Therefore, not both of the output signals become Lo even if a strong disturbance magnetic field is generated.

Also, in the fourth embodiment in which the magnetic detection elements are magnetoresistive elements and detect the magnetic field in the central axis direction of the rotating column 5 and the magnetic field in a direction orthogonal thereto, it is possible to obtain the functions and effects described for the first embodiment.

Although the embodiments of the invention have been described, these embodiments are merely examples and the invention according to claims is not to be limited thereto. These new embodiments and modifications thereof may be implemented in various other forms, and various omissions, substitutions and changes, etc., can be made without departing from the gist of the invention.

Although the configurations shown in the embodiments described above are such that the Hall elements in the first and second embodiments detect a magnetic field in a direction perpendicular to the rotational axis and the magnetoresistive elements in the third and fourth embodiments detect a magnetic field in a direction along rotational axis, it is not limited thereto. For example, the Hall element may be configured to detect the magnetic field in the direction along the rotational axis by arranging so that the normal direction to the magnetic sensing surface is in the same direction as the rotational axis. In this case, the magnet is arranged as in the third embodiment. For example, when the arrangement is such that the relation between the magnetic sensing surfaces of the magnetic detection elements and the magnetic field by the magnet is the same as those in the first to fourth embodiments, it is possible to obtain the same effects.

In addition, although the embodiments in which a determination of the unlock position is made when both the first magnetic detection element 21 and the second magnetic detection element 22 become Lo have been described, it is not limited thereto. It may be configured such that the condition to make a determination of the unlock position is set to Hi and the determination of the unlock position is made when both become Hi. Alternatively, the setting may be such that a combination of Lo and Hi is used to make a determination of the unlock position. Lo/Hi setting is optional.

In addition, although the embodiments in which the magnet is attached to the lateral surface of the rotating support rod 5 to detect the rotational position have been described, it is not limited thereto. For example, the magnet may be attached to a gear that applies a rotational driving force to the rotating body. Alternatively, the magnet may be attached to, e.g., an upper surface instead of the lateral surface. Furthermore, the position detection device may be configured such that the magnet is attached to, e.g., a moving body that moves linearly, instead of the rotating body. In addition, the use application is not limited to the steering lock device.

In addition, the magnet has been described as a permanent magnet but may be an electromagnet.

Note that, all combinations of the features described in these embodiments and modifications are not necessary to solve the problem of the invention. Further, these embodiments and modifications are included within the scope and gist of the invention and also within the invention described in the claims and the range of equivalency.

### REFERENCE SIGNS LIST

1, 2, 3, 4 POSITION DETECTION DEVICE
5 ROTATING SUPPORT ROD
10 MAGNET
11 FIRST MAGNET
12 SECOND MAGNET
21 FIRST MAGNETIC DETECTION ELEMENT
22 SECOND MAGNETIC DETECTION ELEMENT
23 THIRD MAGNETIC DETECTION ELEMENT
30 SUBSTRATE
40 DETERMINATION UNIT

1. A position detection device, comprising:
a magnetic field generating portion to generate a magnetic field and move between a first position and a second position;
a first magnetic detection element to detect a first magnetic field;
a second magnetic detection element to detect a second magnetic field different from the first magnetic field; and
a determination unit to determine that the magnetic field generating portion has reached the first position when the first magnetic detection element and the second magnetic detection element both detect a predetermined threshold value.

2. The position detection device according to claim 1, wherein the magnetic field generating portion generates magnetic fields in two different directions perpendicular to the movement direction, the first magnetic detection element detects one of the magnetic fields in two different directions, and the second magnetic detection element detects the other of the magnetic fields in two different directions.

3. The position detection device according to claim 2, wherein the magnetic field generating portion comprises a single-sided bipolar permanent magnet.

4. The position detection device according to claim 2, wherein the magnetic field generating portion comprises two permanent magnets respectively corresponding to the first magnetic detection element and the second magnetic detection element.

5. The position detection device according to claim 1, wherein the first magnetic detection element comprises a Hall element for N-pole detection, and the second magnetic detection element comprises a Hall element for S-pole detection.

6. The position detection device according to claim 1, wherein the magnetic field generating portion moves on a predetermined circumference, and the first magnetic detection element and the second magnetic detection element are aligned in a central axis direction of the circumference.

7. The position detection device according to claim 1, wherein the magnetic field generating portion is disposed on a circumference of a rotating cylindrical body, and wherein the first and second positions correspond to an unlocked position where a locking member is unlocked and a locked position where the locking member is locked, respectively, the locking member being configured to operate simultaneously with the rotating cylindrical body and to lock a rotation of a steering wheel of a vehicle.

8. The position detection device according to claim 7, wherein magnetic sensing surfaces of the first magnetic detection element and the second magnetic detection element are disposed such that normal lines thereof are each orthogonal to a direction of a rotational axis of the rotating cylindrical body.

9. The position detection device according to claim 7, wherein magnetic sensing surfaces of the first magnetic detection element and the second magnetic detection element are disposed along a direction of a rotational axis of the rotating cylindrical body so as to be equally distant from the magnetic field generating portion when the locking member is at the unlock position.
